(19) United States
(12) Patent Application Publication
(10) Pub. No.: US 2002/0194161 A1
(43) Pub. Date: Dec. 19, 2002

(54) Directed web crawler with machine learning

(76) Inventors: J. Paul McNamee, Ellicott City, MD (US); James C. Mayfield, Silver Spring, MD (US); Martin R. Hall, Sykesville, MD (US); Lien T. Duong, Ellicott City, MD (US); Christine D. Piatko, Columbia, MD (US)

Correspondence Address: Office of Patent Counsel, THE JOHNS HOPKINS UNIVERSITY, Applied Physics Laboratory, 11100 Johns Hopkins Road, Laurel, MD, 20723-6099, US

(21) Appl. No.: 10/121,525

(22) Filed: Apr. 12, 2002

Related U.S. Application Data
(60) Provisional application No. 60/283,271, filed on Apr. 12, 2001.

(51) Int. Cl. G06F 7/00

(52) U.S. Cl. 707/2

(57) ABSTRACT

A web crawler identifies and characterizes an expression of a topic of general interest (such as cryptography) entered and generates an affinity set which comprises a set of related words. This affinity set is related to the expression of a topic of general interest. Using a common search engine, seed documents are found. The seed documents along with the affinity set and other search data will provide training to a classifier to create classifier output for the web crawler to search the web based on multiple criteria, including a content-based rating provided by the trained classifier. The web crawler can perform it's search topic focused, rather than “link” focused. The found relevant content will be ranked and results displayed or saved for a specialty search.

### CROSS-REFERENCE TO RELATED APPLICATIONS

This application claims the benefit of U.S. Provisional application No. 60/283,271, filed on Apr. 12, 2001, which is hereby incorporated by reference in its entirety.

### BACKGROUND OF THE INVENTION

1. Field of the Invention

The present invention relates to locating documents that are generally relevant to an area of interest. Specifically, the present invention is directed to a topic focused search engine that produces a specialized collection of documents.

2. Description of the Related Art

The Internet, and in particular the World Wide Web (Web), is essentially an enormous distributed database containing records with information covering a myriad of topics. These records contain data files and are located on digital computer systems connected to the Web. The systems and data files are identified by location according to a Universal Resource Locator (URL) and by file names. Many data files contain “hyperlinks” that refer to other data files located on possibly separate systems with different URLs. Thus, a computer user with a computer or computer network connected to the Internet can explore the Web and locate information of interest, clicking from one data file to the next while visiting different URLs.

To speed up the searching process, an automated software “robot” or “spider” that “crawls” the Web can be used to collect information about files contained on Web sites. A typical crawler will contain a number of rules for interpreting what it finds at a particular Web site. These rules guide the crawler in choosing which links to follow and which to avoid and which pages or parts of pages to process and which to ignore. This process is important because the amount of information on the Web continues to grow exponentially and only a portion of the information may be relevant to an individual computer user's search.

Crawlers can be divided roughly into two categories that represent the ends of a spectrum: personal crawlers and all-purpose crawlers. Personal crawlers, like SPHINX, allow a computer user to focus a search on specific domains of interest in order to build a fast access cache of URLs. This tool allows a computer user to search text and HTML, perform pattern matching, and look for common Web page transformations. It follows links whose URLs match certain patterns. Because it needs a starting point or root from which to begin its search, the crawler is not automatic. Like many personal crawlers, SPHINX uses a classifier to categorize data files, it uses all-purpose search engines to generate seed documents (e.g., the first 50 hits) and displays a graphical list of relevant documents. Many of these features are common in the art. Personal crawlers are efficient crawlers because they search specified domains of URLs.

Search engines use general purpose web crawlers to download large portions of the Web. The downloaded content is then indexed (offline). Later, when users issue queries, the indices are consulted. The crawling, indexing, and querying generally occur at distinct times. Search engines such as AltaVista™ and Excite^{sm}, assist computer users to search the entire Web for specific information contained in data files. These search engines rely on technology that continuously searches the entire Web to create indices of available data files and information.

All-purpose crawlers may be more effective in locating and retrieving information from URLs relevant to a computer user's query than a personal crawler that may overlook files if it were not directed to the URL. Conversely, they may contain a depth of information not captured by the larger, but generic search engine. The indices of available data files, information and/or URLs created by all-purpose crawlers are occasionally updated. When a computer user submits a query to a search engine, a “hit” list of URLs and associated files is produced from these indices. The resulting hit list, which is also ranked according to certain rules, makes it possible for the computer user to quickly locate and identify relevant information without having to search every Web site on the Internet.

Many of the innovations in Web crawling technology have been aimed at combining the advantages of personal and all-purpose crawlers. The better the crawling technology and ranking scheme employed, the more relevant will be the resulting hit list and the faster the list will be generated.

Simple improvements to basic ranking methodologies include widely accepted scoring techniques. Under these methodologies, each URL and associated file in the index is scored based on various criteria, including the number of occurrences of the computer user's query term in the URL and/or file and the location of the query term in a document. Further scoring may be done based on the frequency of the query term within the collection of documents, the size of the individual documents, and the number of links addressing the document. This last technique creates a site “reputation” score as defined by the concept of “authorities” and “hubs.” A hub is basically a Web page that links to many different pages and Web sites. An authority is a Web page that is pointed to by a number of other Web pages (not including certain large commercial sites such as Amazon.com™). While these methods may narrow a massive linear list of URLs and files into a more manageable one, the ranking scheme is focused on text that matches the query term, as opposed to the more desirable content- or topic-focused approaches. Thus, a text-focused query using the word “Golf” could return a list of URLs and files containing information not only about the sport of golf, but also about a particular German-made automobile.

Other improvements to the “authorities” approach involve ranking the authorities. This method takes a topic and gathers a collection of pages (e.g., first 200 documents from a search engine) and distills them to get the ones that are relevant to the topic. It then adds files to this “root” set of documents based on files that are linked to the root set and produces an augmented set of documents. It then computes the hubs and authorities by weighting them and ranking the results. Other methods include weighting methods that involve the high level domains (e.g., .com, org, net) to rank the documents.

Other improvements to basic crawling techniques include enhancing the speed of returning the hit list. This has been accomplished, for example, by improving the context classification scheme. These improvements rely on techniques for extracting conceptual phrases from the source material (i.e., the initial documents collected in response to a query) and assimilating them into a hierarchically-organized, conceptual taxonomy, followed by indexing those concepts in addition to indexing the individual words of the source text. By doing this, documents are grouped and indexed according to certain concepts derived from the computer user's query. Then, depending on the query terms, only one or a few of the groups or classified indices need to be accessed to prepare the relevant hit list, thus speeding the response time after the query has been entered. This classification by concept technique is done after a crawl or as the crawl progresses. Physically locating this type of system on one or more servers near the indices also speeds the ranking process. This technique, however, unlike the claimed invention, does not necessarily result in a specialized, topic-focused collection of information related the user's topic query.

Other improvements to basic crawling and ranking technology include filters or classifiers, such as support vector machines (SVM), to increase the relevancy of resulting indices. Classifiers are reusable Web- or site-specific content analyzers. SVMs are software programs that employ an algorithm designed to classify, among other things, text into two or more categories. As text classifiers, SVMs have been found to be very fast and effective at sorting documents on the Web, compared to multivariate regression models, nearest neighbor classifiers, probabilistic Bayes models, decision trees and neural networks. SVMs are useful when dealing with several thousand dimensions of data (where a dimension may be equal to a word or phrase). This contrasts to less robust systems, such as neural networks, that may handle hundreds to maybe a thousand dimensions.

A few researchers in the area of text classification have used cosine-based vector models to evaluate content. With this approach, a threshold value must be provided to the crawler to decide whether a document is relevant because the technique contains no starting threshold value. Often, the same threshold is used for all topics instead of varying the threshold in a topic-specific manner. Further, determining a good threshold value can be tedious and arbitrary. Also, while good documents may be relatively easy to find, irrelevant or “bad” documents are often difficult to locate, thus reducing the SVM's ability to accurately classify documents.

Still other improvements to basic Web crawling and classification schemes include the use of advanced graphical displays that further categorize information visually and thereby decrease the time it takes a user to locate relevant information. This improvement involves using selected records to dynamically create a set of search result categories from a subset of records obtained during the crawl. The remaining records can be added to each of the categories and then the categories can be displayed on the user's screen as individual folders. This provides for an efficient method to view and navigate among large sets of records and offers advantages over long linear lists. While this approach relies on sophisticated clustering techniques, it is still dependent on conventional text-based crawling techniques like those mentioned above.

Still other improvements involve disambiguating query topics by adding a domain to the query to narrow the search. For example, where “Golf” is entered by the user as a query, the domain “Sports” could be added to reduce the number of irrelevant hits. This improvement involves using software residing on the user's computer that interfaces with one or more of the existing search engines available on the Internet. While this approach may reduce search time, it is still dependent on conventional search engines.

The above improvements have been employed in a variety of ways. For example, e-mail spam filtering technologies rely on vector models to evaluate the content of e-mail subject lines and text to differentiate “good” from “bad” e-mail. Virus detection technologies also rely on these improvements. Also, automatic document classifiers rely on conventional vector models to distinguish good and bad documents. Unfortunately, these improvements have or will be eventually overcome by the sheer size and growth of the Internet. New content added to existing Web sites and entirely new Web sites with fresh content strain current technologies.

It would be desirable, therefore, if there was a system and method for crawling the Web and creating relevant indices that is more effective (i.e., produces higher quality results) and efficient (i.e., has a faster response time) compared to conventional technology. For example, it would be highly desirable if a computer user were able to initiate a topic query search that employs a search tool that is sharply focused on the user's topics, thereby reducing the amount of “hits” that are irrelevant to the user's query. It would also be desirable if the crawler could reduce computing resource requirements, decrease the size of URL indices and file information, and increase response speed.

### SUMMARY OF THE INVENTION

It is an object of the invention to receive a query representative of a class of users or a single user and clarify the concept into words, phrases, and documents relevant to the user(s) query.

It is another object of the invention to obtain and retrieve documents from databases and to use the documents to train a document classifier.

It is another object of the invention to direct a Web crawler using rules based on the results of a document classifier.

It is still another object of the invention to improve content-based methods that is also compatible with other criteria such as link-based techniques.

In accordance with the purpose of the invention as broadly described herein, the present invention provides a system and method with computer software for directed Web crawling and document ranking. The invention involves a general purpose digital computer or network connected to a network of information plus at least one general purpose digital server containing a plurality of databases with information, including, but not limited to data, images, sounds or multi-media files. The computer user's software receives and processes a computer user's specific expression of a topic (i.e., a query). Either the computer user's computer or a server connected to a network may contain software that directs a Web spider to locate documents that are highly relevant to the computer user's query. In this case, the spider may be directed in several ways common in the art, such as by file content, link topology or meta-information about a document or URL (including, but not limited to, information about the author or the reputation of the site, for example). The software directs a browser to display or store an index list of ranked URLs and files related to the query.

The system includes a query interface, which is typically a Web browser, residing on the computer user's network. It accepts a query in the form of a single word, phrase, document or set of documents, which may or may not be in English. The system produces an affinity set, which is a ranked list of terms, phrases, documents or set of documents related to the query. These items are derived from statistics about the document collection. The system also includes a directed Web crawler that is used to discover information on the Web and to create a document collection. A Support Vector Machine (SVM) is used to partition documents into two classes, which may be grouped as “on-topic” and “off-topic,” based on the training the SVM receives. This involves mapping words according to mathematical clustering rules. The SVM classifier can handle several thousand dimensions. The crawler can continuously update an index containing a ranked list of URLs from which the user may select a file. Using the above, the system crawls the Internet looking for relevant documents using the trained SVM, updating the index list of URLs and files and thereby creating a specialized collection of related documents that satisfy the computer user's interest. The system, therefore, creates a focused collection of related or specialized documents of particular interest to the user.

### DESCRIPTION OF THE DRAWINGS

FIG. 1 is a diagram illustrating the directed Web crawling system according to the present embodiment.

FIG. 2 is a flow chart illustrating the directed Web crawling method according to the present embodiment.

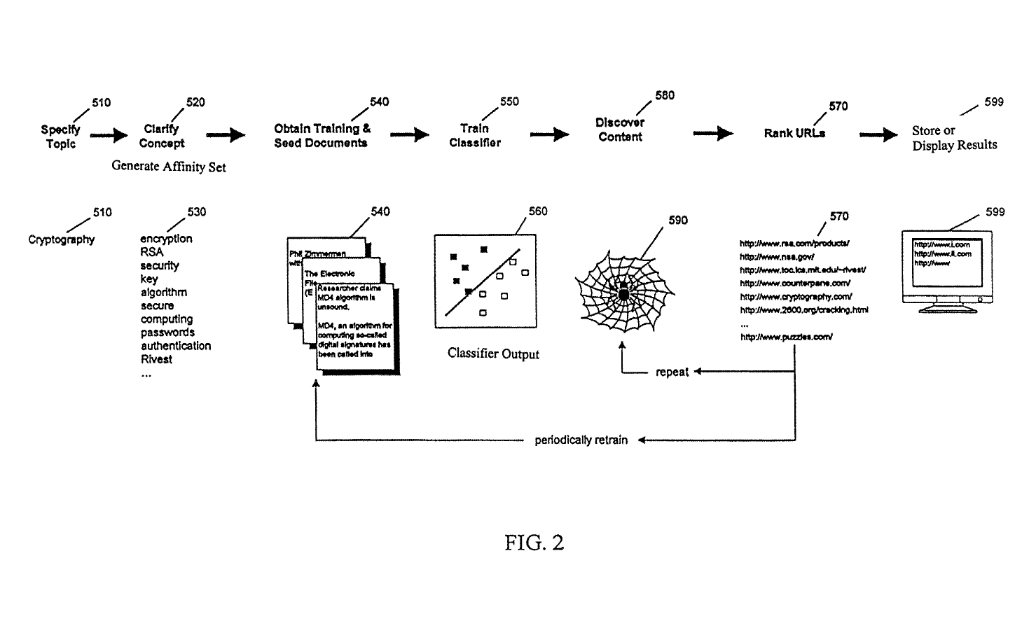

### DESCRIPTION OF THE PREFFERED EMBODIMENT

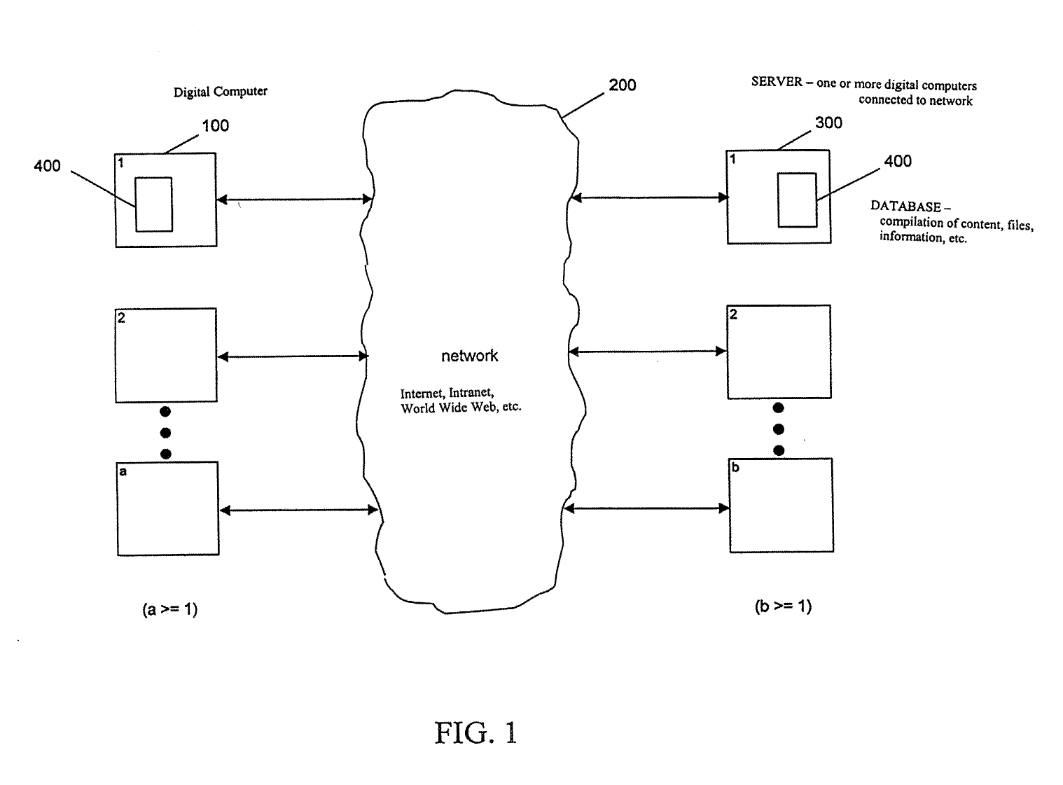

The web crawler of the present embodiment creates a specialized collection of documents. It operates under a system as depicted in FIG. 1. The body of information to be searched (network, internet, intranet, world wide web, etc.) 200 is connected to at least one digital computer 100 with a database 400 which may contain the compilation of content, files, and other information. All data that must be stored or any data that is generated in the system may be kept in the database 400 or on the network to be retrieved at any time during system operation.

In the present embodiment, the system begins by identifying and characterizing an expression of a topic of general interest 510 entered (such as cryptography) and generates an affinity set 530 which comprises a set of related words as described above in the summary of the invention. The affinity set may be stored in a database. The generation of an affinity set is described in a co-pending non-provisional patent application ser. No. 60/271,962 which is herein incorporated by reference. This affinity set is related to the requested expression of a topic of general interest and is used for the training of the classifier. 540 Seed documents related to the requested expression of a topic of general interest will be obtained from a general purpose search engine like Google™ or AltaVista™. These seed documents 540 will include both relevant and irrelevant documents in relation to the requested expression of a topic of general interest.

A Support Vector Machine (SVM) is used to provide the basis needed for separating the relevant and irrelevant seed documents. Each vector of the SVM will contain training data for the classifier. There may also be several SVMs which used together will create additional training data for a database of training information. Several dimensions can be created with several vectors of training data. The data contained in the SVM provides training and learning for the classifier in classifying either on-topic or off-topic documents from a set of seed or searched documents. Training for the classifier enables the classifier to generate classifier output 560. The web crawler compares web content against this classifier output for it's relevancy and for the ranking of found documents or web pages. The ranking of documents or web pages is useful for the display of these items for either a group of users or individual user. The ranking of documents or webpages is also useful for the storage of these items for subsequent focus of specialized searches for relevant information.

The web crawler 590 will now be able to discover relevant content 580 based on multiple criteria, including a content-based rating provided by the trained classifier. The web crawler of the present embodiment is now topic focused, rather than “link” focused. This means the found relevant content is now ranked (in the present embodiment URLs are given a ranking 570 according to their relevance to the topic). The found URLs are then displayed 599 to the user or group of users as a response to the inquiry made or stored as a specialized database for iterative focused queries from the specialized group of found searches.

In the current embodiment of the invention, there is also the opportunity for the system to periodically retrain the classifier so that generated classifier output will be more relevant to requested queries. This will permit greater efficiency in the system's searching process. The additional training will make the classifier more skilled at searching. This will also result in more relevant searches made and results found.

The current embodiment describes a binary classification system of separating information, although many dimensions of classification separation can exist. The extra dimensions of classification will create further depth of searching adding to the efficiency and relevancy of found results.

Two technologies are employed in the current embodiment. The first is an affinity set technology which characterizes the content of the documents or collections of documents and provides important differences between on-topic and off-topic documents. This technique provides a ranked list of terms related to an input term, phrase, document or set of documents. The terms are derived from statistics about the document collection. As stated above, additional description may be found in a co-pending patent application ser. No. 60/271,962 which is herein incorporated by reference. The second technique involves using a machine learning technique to classify documents. These can include Support Vector Machines (SVMs) to partition documents into two classes—on-topic and off-topic, cosine-based vector modes and neural networks.

The affinity set technique works for any language (not just English), is fully automatic and relies only on having a large collection of text, and the “input” can be of any length, e.g., a word, a sentence, an entire document. The present invention is able to add additional context to a short web query. It can also improve the processing of text searches, disambiguate word sense (e.g., jaguar the car vs. jaguar the NFL team), provide automatic thesaurus instruction and document summarization and query translations (e.g., an English query into French) when using parallel corpora.

In the current embodiment, the invention creates a focused collection of specialty documents from related sites that will have their own specialty documents but may also have specialty documents from other related specialty sites.

In the current embodiment, a single user, group of users or system may use the invention to input a singe term, sentence or an entire document.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

We claim:

1. A system having computer-readable code associated with a network computer environment and one or more servers having one or more databases associated therewith containing information about database content for providing a network search in response to a user's input, said system comprising:
at least one computer, for receiving one or more queries, searching a plurality of databases, and displaying a specialized collection of documents related to said one or more queries;
at least one network, operatively connected to said at least one computer, for accessing said plurality of databases and transferring information from said plurality of databases to said at least one network;
at least one server, operatively connected to said at least one network, for storing said plurality of databases; and
software means, operatively connected to said at least one computer, for preparing an affinity set related to said one or more queries, identifying information in said plurality of databases, creating an index relating to said information in said plurality of databases, creating a set of seed documents based on information in said plurality of databases, training a classifier to classify said information in said plurality of databases using said seed documents, searching said network for relevant documents using a binary system created by said classifier, creating said specialized collection of documents related to said one or more queries, creating a ranked list of said specialized collection of documents, and displaying said ranked list on said at least one computer.

2. A method of searching a database of records and displaying the records, said method including the steps of:
(a) receiving a user's request query, said query including one or more words, phrases or documents, for defining a topic associated with said user's request query;
(b) generating an affinity list, said list including one or more words, phrases or documents related to said user's request query;
(c) causing one or more servers to locate and retrieve seed documents, said seed documents including information relevant and irrelevant to said affinity list;
(d) training a binary classifier, said binary classifier being trained using said seed documents to define documents;
(e) causing a web spider to locate and retrieve documents related to said user's request query, said spider being directed to documents by said binary classifier;
(f) ranking URLs associated with said documents located by said web spider; and
(g) displaying said ranking of URLs.
